(19) United States
(12) Patent Application Publication
(10) Pub. No.: US 2002/0160925 A1
(43) Pub. Date: Oct. 31, 2002

(54) Composition and method for bleaching a substrate

(75) Inventors: Ronald Hage, Vlaardingen (NL); Maria Johanna Lagerwaard-Lier, Vlaardingen (NL); Joachim Lienke, Vlaardingen (NL); Cynthia Margaret Ligeon, Vlaardingen (NL); Patricia Petersen, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/073,437

(22) Filed: Feb. 11, 2002

(30) Foreign Application Priority Data
Feb. 13, 2001 (GB) 0103526.0

(51) Int. Cl. C11D 3/00

(52) U.S. Cl. 510/311; 510/312; 510/313

(57) ABSTRACT

The invention relates to catalytically bleaching substrates, especially laundry fabrics, with a transition metal catalyst that bleaches tea type stains in the presence of atmospheric oxygen.

### FIELD OF INVENTION

This invention relates to compositions and methods for catalytically bleaching substrates in the absence of a peroxyl species using a defined class of ligand or complex as catalyst.

### BACKGROUND OF INVENTION

The use of bleaching catalysts for stain removal has been developed over recent years. The recent discovery that some catalysts are capable of bleaching effectively with air has recently become the focus of some interest, for example, GB applications: 9906474.3; 9907714.1; and 9907713.3 (all Unilever). As with any cleaning product a more economical use of active components and effective stain bleaching profile is sought.

### SUMMARY OF INVENTION

We have found that the majority of air bleaching catalysts, in air bleaching mode, are more effective against certain types of stains than others.

The consumer is aware what constitutes a catechol-type or polyphenolics-type or polycyclic hydroxylated aromatic-type stain but not in those terms. The consumer recognizes these stains as tea, coffee, blackberry, blueberry, blackcurrant, red wine, banana and the like. These stains are characteristic and distinct from oily food type stains such as tomato oil stain, curry oil stain, mango stain, annatto derived stain, colorau derived stain, and sebum derived stain etc.

It is the tea, coffee, blackberry, blueberry, blackcurrant, red wine, banana and stains of this type that are presently more resistant to bleaching with air than with a peroxyl species, with or without a peroxyl activating catalyst. These stains are referred to herein as “tea type stains”.

These “tea type stains” are generally resistant to any air bleaching and in many cases are darkened by such treatment. Nevertheless, we have surprisingly found that a specific class of copper transition metal complex is capable of beaching the aforementioned stains.

The present invention provides a composition for bleaching a catechol-type or polyphenolics-type or polycyclic hydroxylated aromatic-type stain on a substrate, comprising a copper transition metal catalyst, or precursors thereof, of a macrocyclic ligand of formula (I)

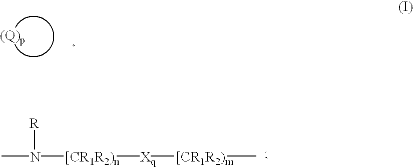

X is independently selected from: N, S, O, and P;

q is independently selected from: 0 and 1;

R is independently selected from: hydrogen, alkyl, alkenyl, alkylene;

R1 and R2 are independently selected from: H, C1-C4-alkyl, and C1-C4-alkylhydroxy;

n and m are independently selected from: 0, 1, 2 and 3, and wherein if n=0 then q=0; with the proviso that n+m+q takes a value selected from 2 and 3.

p is independently selected from: 3, 4, 5 and 6, wherein the ring size of the macrocyclic ligand=p(1+n+q+m) and is at least 9 and less than or equal to 15, wherein in an aqueous solution at least 10%, preferably at least 50% and optimally at least 90% of any bleaching of a substrate is effected by oxygen sourced from the air.

It is preferred that the composition comprises a copper transition metal catalyst rather than precursors thereof; it is particularly preferred that the copper is in the form of Cu II.

The present invention also extends to a method of treating a tea type stain with a bleaching composition of the present invention.

The present invention also extends to a commercial package together with instructions for its use.

### DETAILED DESCRIPTION OF THE INVENTION

The Bleach Catalyst

The bleach catalyst of the present invention is specifically that of a copper complex. The ligand of the copper complex is as described herein. The bleach catalyst is provided in the form of a bleaching composition, which is generally added to tap water to provide an aqueous medium.

In typical washing compositions the level of the catalyst is such that the in-use level is from 0.1 μM to 50 mM, with preferred in-use levels for domestic laundry operations falling in the range 1 to 100 μM. Higher levels may be desired and applied in industrial bleaching processes, such as textile and paper pulp bleaching.

Preferably, the aqueous medium has a pH in the range from pH 6 to 13, more preferably from pH 6 to 11, still more preferably from pH 8 to 11, and most preferably from pH 8 to 10, in particular from pH 9 to 10.

The bleaching composition of the present invention has particular application in detergent formulations, especially for laundry cleaning. Accordingly, in another preferred embodiment, the present invention provides a detergent bleach composition comprising a bleaching composition as defined above and additionally a surface-active material, optionally together with detergency builder.

The bleach composition according to the present invention may for example contain additional surface-active material in an amount of from 10 to 50% by weight. The surface-active material may be naturally derived, such as soap, or a synthetic material selected from anionic, nonionic, amphoteric, zwitterionic, cationic actives and mixtures thereof. Many suitable actives are commercially available and are fully described in the literature, for example in “Surface Active Agents and Detergents”, Volumes I and II, by Schwartz, Perry and Berch.

Typical synthetic anionic surface-actives are usually water-soluble alkali metal salts of organic sulphates and sulphonates having alkyl groups containing from about 8 to about 22 carbon atoms, the term “alkyl” being used to include the alkyl portion of higher aryl groups. Examples of suitable synthetic anionic detergent compounds are sodium and ammonium alkyl sulphates, especially those obtained by sulphating higher (C₈-C₁) alcohols produced, for example, from tallow or coconut oil; sodium and ammonium alkyl (C₉-C₂₀) benzene sulphonates, particularly sodium linear secondary alkyl (C₁₀-C₁₅) benzene sulphonates; sodium alkyl glyceryl ether sulphates, especially those ethers of the higher alcohols derived from tallow or coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralised with sodium hydroxide; sodium and ammonium salts of fatty acid amides of methyl taurine; alkane monosulphonates such as those derived by reacting alpha-olefins (C₈-C₂₀) with sodium bisulphite and those derived by reacting paraffins with SO₂ and Cl₂ and then hydrolysing with a base to produce a random sulphonate; sodium and ammonium (C₇-C₁₂) dialkyl sulphosuccinates; and olefin sulphonates, which term is used to describe material made by reacting olefins, particularly (C₁₀-C₂₀) alpha-olefins, with SO₃ and then neutralising and hydrolysing the reaction product. The preferred anionic detergent compounds are sodium (C₁₀-C₁₅) alkylbenzene sulphonates, and sodium (C₁₆-C₁₈) alkyl ether sulphates.

Examples of suitable nonionic surface-active compounds which may be used, preferably together with the anionic surface-active compounds, include, in particular, the reaction products of alkylene oxides, usually ethylene oxide, with alkyl (C₆-C₂₂) phenols, generally 5-25 EO, i.e. 5-25 units of ethylene oxides per molecule; and the condensation products of aliphatic (C₈-C₁₈) primary or secondary linear or branched alcohols with ethylene oxide, generally 2-30 EO. Other so-called nonionic surface-actives include alkyl polyglycosides, sugar esters, long-chain tertiary amine oxides, long-chain tertiary phosphine oxides and dialkyl sulphoxides.

Amphoteric or zwitterionic surface-active compounds can also be used in the compositions of the invention but this is not normally desired owing to their relatively high cost. If any amphoteric or zwitterionic detergent compounds are used, it is generally in small amounts in compositions based on the much more commonly used synthetic anionic and nonionic actives.

The detergent bleach composition of the invention will preferably comprise from 1 to 15% wt of anionic surfactant and from 10 to 40% by weight of nonionic surfactant.

The bleach composition of the present invention may also contain a detergency builder, for example in an amount of from about 5 to 80% by weight, preferably from about 10 to 60% by weight.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate; nitrilotriacetic acid and its water-soluble salts; the alkali metal salts of carboxymethyloxy succinic acid, ethylene diamine tetraacetic acid, oxydisuccinic acid, mellitic acid, benzene polycarboxylic acids, citric acid; and polyacetal carboxylates as disclosed in U.S. Pat. No. 4,144,226 and U.S. Pat. No. 4,146,495.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the compositions of the invention may contain any one of the organic and inorganic builder materials, though, for environmental reasons, phosphate builders are preferably omitted or only used in very small amounts. Typical builders usable in the present invention are, for example, sodium carbonate, calcite/carbonate, the sodium salt of nitrilotriacetic acid, sodium citrate, carboxymethyloxy malonate, carboxymethyloxy succinate and water-insoluble crystalline or amorphous aluminosilicate builder materials, each of which can be used as the main builder, either alone or in admixture with minor amounts of other builders or polymers as co-builder.

Apart from the components already mentioned, the bleach composition of the present invention can contain any of the conventional additives in amounts of which such materials are normally employed in fabric washing detergent compositions. Examples of these additives include buffers such as carbonates, lather boosters, such as alkanolamides, particularly the monoethanol amides derived from palmkernel fatty acids and coconut fatty acids; lather depressants, such as alkyl phosphates and silicones; anti-redeposition agents, such as sodium carboxymethyl cellulose and alkyl or substituted alkyl cellulose ethers; stabilisers, such as phosphonic acid derivatives (i.e. Dequest® types); fabric softening agents; inorganic salts and alkaline buffering agents, such as sodium sulphate and sodium silicate; and, usually in very small amounts, fluorescent agents; perfumes; enzymes, such as proteases, cellulases, lipases, amylases and oxidases; germicides and colourants.

Transition metal sequestrants such as EDTA, and phosphonic acid derivatives such as EDTMP (ethylene diamine tetra(methylene phosphonate)) may also be included, in addition to the ligand specified, for example to improve the stability sensitive ingredients such as enzymes, fluorescent agents and perfumes, but provided the composition remains bleaching effective. However, the composition according to the present invention containing the ligand, is preferably substantially, and more preferably completely, devoid of transition metal sequestrants (other than the ligand). Nevertheless, an advantage may likely be obtained by incorporating in the composition a sequestrant that has a higher binding coefficient for Fe ions or Mn ions over that of Cu ions. A description of the various sequestrants and binding constants can be found in A. E.Martell, Pure and Appl. Chem., vol 50, 813-829 (1978).

The composition containing the bleach catalyst may contain additional enzymes as found in WO 01/00768 A1 page 15, line 25 to pagel9, line 29, the contents of which are herein incorporated by reference.

Experimental Protocol

The tea stain was prepared as follows. A concentrated tea solution was prepared and cotton cloths were immersed in this solution. The cloths were rinsed and dried for 24 h at 37 C. After that, the cloths were washed for 30 min at 30° C. in a 10 mM carbonate buffer, rinsed and then dried again for 24 h.

The copper bleach catalysts used for bleaching a tea stain were [Cu₂(OH)₂(Me₃tacn)₂](PF₆)₂ (1) and [Cu₂(OH)₂(Me₃tacn)₂](ClO₄)₂ (2).

Compounds 1 and 2 were prepared by modified literature methods (P. Chaudhuri, et al., Angew. Chem. Int. Ed. Engl., 24, 57 (1985)). One skilled in the art will appreciate that many different copper salts may be used to form the complex, e.g., copper II chloride, copper II nitrate, copper II sulphate, copper II acetate, copper II phosphate, copper II citrate, copper perchlorate, etc.

In the first series of experiments the above-mentioned compounds were tested in buffer solutions containing surfactant (NaLAS). Tea stains were used as bleach monitor.

In an aqueous solution containing 10 mM carbonate buffer (pH 10) with 0.6 g/l Na-LAS and Cu-complex 1 (30 μM), tea stained cloths were added and kept in contact with the solution under agitation for 120 minutes at 30° C. In comparitive experiments the wash solution only buffer with NaLAS was used. After the wash, the cloths were rinsed with water and subsequently dried at 30° C. and the change in colour was measured immediately after drying with a Linotype-Hell scanner (ex Linotype) (t=0 in the table. The change in colour (including bleaching) is expressed as the ≢E value versus white; a lower ΔE value means a cleaner cloth. The measured colour difference (ΔE) between the washed cloth and the unwashed cloth is defined as follows:

ΔE=[(ΔL)²+(Δa)²+(≢b)²]^{½}

wherein ΔL is a measure for the difference in darkness between the washed and unwashed test cloth; Δa and Δb are measures for the difference in redness and yellowness respectively between both cloths. With regard to this colour measurement technique, reference is made to Commission International de l'Eclairage (CIE); Recommendation on Uniform Colour Spaces, colour difference equations, psychometric colour terms, supplement no 2 to CIE Publication, no 15, Colormetry, Bureau Central de la CIE, Paris 1978. The results are shown below in the tables.

TABLE 1
Bleach results obtained on a tea stain expressed in
ΔE; a lower value means a whiter cloth.

| | ΔE |
|---|---|
| Buffer/NaLAS | 15 |
| Buffer/NaLAS + 30 μM 1 | 13 |

In the second series tests were done in bottles (25 mL solution), each bottle containing two pieces of tea stains (4×4 cm). In the first series a 10 mM carbonate buffer pH 10 15 in millipore water with 0.6 g/L NaLAS was used and in the second series a detergent formulation A (5 g/L) in hardened water (16 FH) was used.

| Formulation A: | |
|---|---|
| Na-LAS: | 8.7% |
| Nonionic 7EO, branched: | 4.5% |
| Nonionic 3EO, branched: | 2.4% |
| Soap: | 1.1% |
| Zeolite A24 (anhydrous) | 29.6% |
| Na-citrate 2 aq: | 3.5% |
| SCMC - sodium carboxymethylcellulose (68%) | 0.5% |
| Moistures, salts, NDOM | 4.8% |
| PVP: K-15 solution, ISP technologies, Inc. | 0.6% |

The cloths were washed for 60 min at 40° C. After the wash, the cloths were rinsed with water and subsequently dried, and the change in reflectance at 460 nm was measured immediately after drying on a Minolta CM-3700d spectrophotometer including a UV-Vis filter before and after treatment.

The difference in ΔR between both reflectance values gives a measure of the bleaching performance of the system on the stain, i.e. a higher ≢R value corresponds to an improved bleaching performance. The results for bleaching performance are shown in Table 2 below:

TABLE 2
Bleach results obtained on a tea stain; a higher
value means a whiter cloth.

| Composition | ΔR |
|---|---|
| Buffer/NaLAS | 1 |
| Buffer/NaLAS + 10 μM 1 | 3 |
| Buffer/NaLAS + 10 μM 2 | 3 |
| Buffer/NaLAS + 30 μM 2 | 6 |
| 5/g L Formulation A | 1.5 |
| 5/g L Formulation A 30 μM 1 | 5.0 |

The results shown in tables 1 and 2 show that the complexes 1 and 2 exhibit a significant improved bleaching effect as compared with the blank. This effect has been found in both buffer/NaLAS formulation and a typical full detergent formulations both in the absence of any added peroxy bleach.

What is claimed is:

1. A composition for bleaching a catechol-type or polyphenolics-type or polycyclic hydroxylated aromatic-type stain on a substrate, comprising a copper transition metal catalyst, or precursors thereof, of a macrocyclic ligand of formula (I) 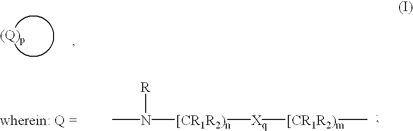
X is independently selected from: N, S, O, and P;
q is independently selected from: 0 and 1;
R is independently selected from: hydrogen, alkyl, alkenyl, alkylene;
R1 and R2 are independently selected from: H, C1-C4-alkyl, and C1-C4-alkylhydroxy;
n and m are independently selected from: 0, 1, 2 and 3, and wherein if n=0 then q=0; with the proviso that n +m +q takes a value selected from 2 and 3.
p is independently selected from: 3, 4, 5 and 6, wherein the ring size of the macrocyclic ligand=p(1+n+q+m) and is at least 9 and less than or equal to 15, wherein in an aqueous solution at least 10%, preferably at least 50% and optimally at least 90% of any bleaching of a substrate is effected by oxygen sourced from the air.

2. A composition according to claim 1, wherein p is selected from: 3 and 4.

3. A composition according to claim 1, wherein x is O or N.

4. A composition according to claim 1, wherein q=0.

5. A composition according to claim 1, wherein the macrocyclic ligand is a 12-memembered ring with 3 N donors.

6. A composition according to claim 1, wherein p=3 and p(1+n+q+m) takes a value selected from 9, 10, 11, and 12.

7. A composition according to claim 1, wherein R1 and R2 are H.

8. A composition according to claim 1, Wherein the macrocyclic ligand of formula (I) is:

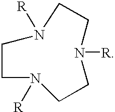

9. A composition according to claim 1, wherein R is Me.

10. A composition according to claim 1, wherein a copper transition metal catalyst is present and the copper is in the form of Cu II.

11. A composition according to claim 1 where the macrocyclic ligand is in the form of a free ligand for chelating to a copper ion derived from a source selected from: the composition, tap water, and a stain on the substrate.

12. A method of bleaching a tea type stain which comprises the step of treating a substrate having a tea with a composition as defined in claim 1, wherein at least 10% of any bleaching of the substrate being effected by oxygen sourced from the air.

13. A method according to claim 12, wherein at least 50% of any bleaching of the substrate being effected by oxygen sourced from the air.

14. A method according to claim 12, wherein at least 90% of any bleaching of the substrate being effected by oxygen sourced from the air.
